(19) United States
(12) Patent Application Publication
(10) Pub. No.: US 2006/0256556 A1
(43) Pub. Date: Nov. 16, 2006

(54) Electrical connector

(76) Inventor: Huang-Chou Huang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/128,273

(22) Filed: May 13, 2005

(51) Int. Cl. F21V 21/00

(52) U.S. Cl. 362/249

(57) ABSTRACT

An electrical connector has a seat and a casing. The seat has a body, a first chamber defined in an interior of the body, two channels defined in two opposed top ends of the body, multiple Light Emitting Diodes (LED) provided in the channels, multiple terminals formed in a row and provided downwards under the LEDs, and two transparent slats mounted in front of the channels. The LEDs can be connected to a circuit board via the terminals being provided downwards. Hence, the cost of the manufacture of the LEDs is decreased because the feet of the LED are straight without being bent to connect to the circuit board.

### BACKGROUND OF THE INVENTION

1. Field of the Invention

The present invention relates to an electrical connector, and more particularly to an electrical connector which can substantially transmit light.

2. Description of Related Art

With rapid computer development, an electrical connector, which is responsible for communicating with signals, is connected to a joint of applications such as computers, telephones, ear phones, etc., however, it is difficult for a user to identify the status of the electrical connector. To solve the aforesaid problem, a first conventional electrical connector is invented into the market and has a Light Emitting Diode (LED) in an interior thereof, and a plate which can transmit light to a surface thereof. In usage, the light is weakened due to reflection and wastage. However, to more efficiently use the light transmission generally increases the cost.

A second electrical connector is composed of an isolated body, a seat, multiple terminals inserted into the seat, and a channel defined in a front side of the seat. LEDs are mounted on circuit board via feet thereof being inserted into the seat. When the LEDs are powered on, the light can directly transmit to the surface of the electrical connector.

However, disadvantages of the connector are as follow:

1. The feet of the electrical connector need to be bent so that they can be fastened to the circuit board.

2. The cost of manufacture of the feet is high as they must be bent to connect to the circuit board.

Therefore, the invention provides an electrical connector to mitigate or obviate the aforementioned problems.

### SUMMARY OF THE INVENTION

The main objective of the present invention is to provide an electrical connector which can enhance an efficiency of light transmission.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is an exploded perspective view of the electrical connector in accordance with the present invention; and

FIG. 3 is a perspective view of a body of the electrical connector in accordance with the present invention.

### DETAILED DESCRIPTION OF THE PREFERRED EMBODIMENT

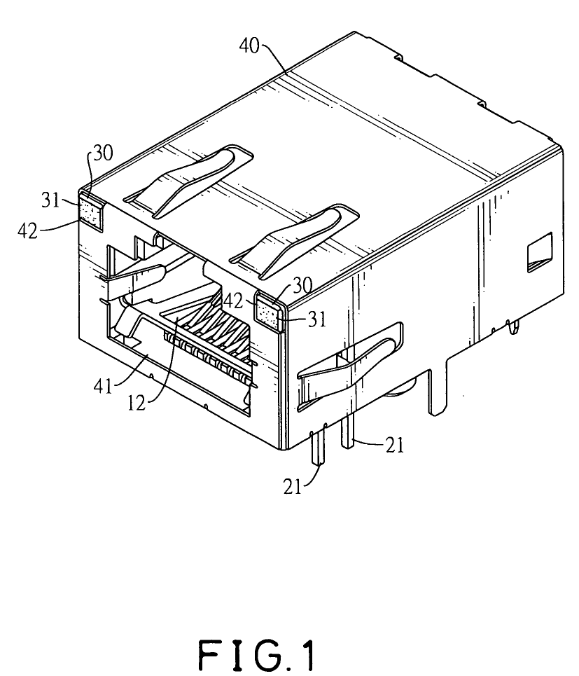

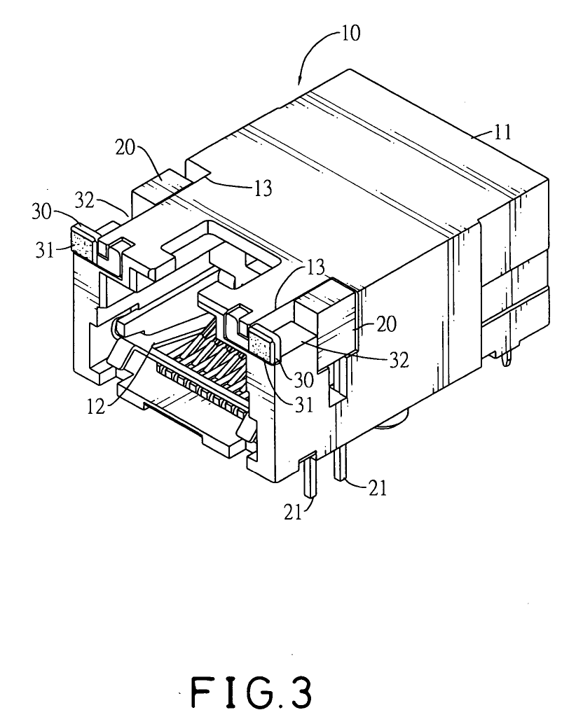

With reference to FIGS. 1-3, an electrical connector has a seat (10) and an iron casing (40). The seat (10) has a plastic body (11). A first chamber (12) is defined in an interior of the body (11) and two channels (13) are respectively defined in two opposed lateral sides of the body (11). Light emitting diodes (LED) (20) are received into the channels (13), and multiple terminals (21) formed in rows are directly inserted into the channel (13) and extend out of the channels (13) downwards thereby being provided on an electrical board. The LEDs (20) are electrically connected to the multiple terminals (21). Multiple transparent slats (30), which are respectively covered with a translucent surface (31), are provided in two opposed top ends of the channels (13). There are two rooms (32), each of which is defined between the respective translucent surfaces (31) and the LED (20). The body (10) is covered with the iron casing (40) and a second chamber (41), which can be inserted into the first chamber (12), is defined in an interior of the iron casing (40). Two holes (42) corresponding to the transparent slats (30) are respectively defined in two opposed top ends of the second chamber (41) so that the light can permeate through the transparent slats (30) and the holes (42).

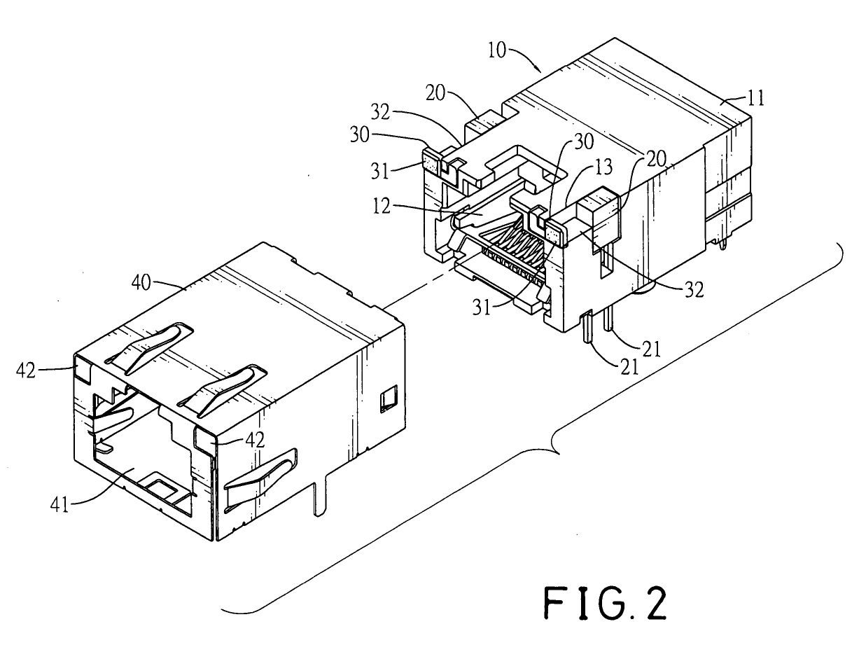

With reference to FIGS. 1-2, the seat (10) is received in the casing (40) and the LEDs (20) can be lit due to the terminals (21) being connected to a power supply. The light from the LEDs (20) can pass through the rooms (32), the transparent slats (30), the translucent surface (31), and the holes (42) in turn so that luminous intensity of the LEDs (20) strengthens and function of the LED (20) can be identified.

Hence, advantages of the electrical connector are described as follows:

1. The LEDs (20) can be connected to the circuit board via the terminals (21) being provided downwards, so that the feet of the LED (20) do not need to be long.

2. The cost of the manufacture of the LEDs (20) is decreased because the feet of the LED (20) are straight without being bent to connect to the circuit board.

3. The light is efficiently transmitted due to the translucent surface expanding the light range.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a seat (10) having a body (11), a first chamber (12) defined in an interior of the body (11), and two channels (13) respectively defined in two opposed top ends of the body (11), multiple Light Emitting Diodes (LED) (20) provided in the channels (12), multiple terminals (21) formed in a row and provided downwards under the LEDs (20), two transparent slats (30) mounted in front of the channels (13), and two rooms (32) defined between the LEDs (20) and the transparent slats (30); and
a casing (40) mounted around the seat (10) and having a second chamber (41) defined in an interior of the casing (40) and inserted into the first chamber (12), and two holes (42) respectively defined in two opposed top ends of the casing (40).

2. The electrical connector as claimed in claim 1, wherein two translucent surfaces (31) are respectively provided in front of the transparent slats (30).
